(19) United States
(12) Patent Application Publication
(10) Pub. No.: US 2007/0098413 A1
(43) Pub. Date: May 3, 2007

(54) Optical logic element

(76) Inventors: Joo-youp Kim, Seongnam-si (KR); Sang-kook Han, Seoul (KR)

Correspondence Address: LEE & MORSE, P.C., 3141 FAIRVIEW PARK DRIVE, SUITE 500, FALLS CHURCH, VA, 22042, US

(21) Appl. No.: 11/583,793

(22) Filed: Oct. 20, 2006

(30) Foreign Application Priority Data
Oct. 22, 2005 (KR) 10-2005-0099942

(51) Int. Cl. H04B 10/04

(52) U.S. Cl. 398/188

(57) ABSTRACT

An optical logic element includes a first interferometer modulating a continuous optical signal in response to first and second optical signals to output a first modulation signal, and a second interferometer modulating the continuous optical signal in response to a sum signal equal to the sum of the first and second optical signals to output a second modulation signal. The first and second modulation signals and the sum signal are respectively the results of predetermined logic operations performed on the first and second optical signals.

### BACKGROUND OF THE INVENTION

1. Field of the Invention

The present invention relates to an optical logic element. More particularly, the present invention relates to an optical logic element using an interferometer realized using a semiconductor optical amplifier (SOA).

2. Description of the Related Art

Forming an ultrahigh optical communication network may include facilitating networking functions, e.g., switching, signal re-generating, addressing, header identifying, data encoding and encrypting, pattern matching, and the like. Also, an optical logic element, i.e., an all-optical logic gate, may be required to realize optical communication networking functions.

SOAs are widely used to realize all-optical logic gates used in optical communications. A non-linear optical phenomenon, e.g., cross gain modulation (XGM), cross phase modulation (XPM), cross polarization modulation (XPoIM), four wave mixing (FWM), or the like, may occur in such an SOA. All-optical logic gates may be realized using the non-linear optical phenomenon occurring in the SOA.

As a particular example, SOAs may be used to create a Mach-Zehnder interferometer (MZI) using XPM. Since an SOA-MZI consumes a small amount of power, is simple, easily integrated, stable, has a low extinction ratio, and generates a signal at high speed, the SOA-MZI is very useful for realizing all-optical logic gates. However, when the SOA-MZIs are used, only an exclusive or (XOR) circuit can be realized.

A method of realizing XOR circuits using XGM of SOAs has been proposed. However, XGM may result in a low extinction ratio and a low signal quality. Thus, this method may not be appropriate for high speed operation.

Further, since logic circuits may be generally realized by NOR circuits or NAND circuits, all-optical NOR circuits or NAND circuits are required to realize efficient optical communication networking.

### SUMMARY OF THE INVENTION

The present invention is therefore directed to all optical logic circuits, which substantially overcome one or more of the problems due to the limitations and disadvantages of the related art.

It is therefore a feature of an embodiment of the present invention to provide an all optical logic element that can realize a NOR circuit.

It is therefore another feature of an embodiment of the present invention to provide an all optical logic element that can realize a NAND circuit.

It is yet another feature of an embodiment of the present invention to provide an all optical logic element that can realize XOR, NOR, OR and NAND circuits.

At least one of the above and other features and advantages of the present invention may be realized by providing an optical logic element performing a logic operation on optical signals using an interferometer using a counter-propagation method, including: a first interferometer modulating a continuous optical signal in response to first and second optical signals to output a first modulation signal; and a second interferometer modulating the continuous optical signal in response to a sum signal equal to the sum of the first and second optical signals to output a second modulation signal. The first and second modulation signals and the sum signal may be respectively results of predetermined logic operations performed on the first and second optical signals.

The first interferometer may include a first modulator modulating a phase of the continuous optical signal in response to the first optical signal and outputting the continuous optical signal; and a second modulator phase modulating the phase of the continuous optical signal in response to the second optical signal and outputting the continuous optical signal. The first modulation signal may be obtained by summing outputs of the first and second modulators.

The first modulator may include a first optical amplifier performing cross phase modulation (XPM) on the continuous optical signal in response to the first optical signal and a first phase shifter shifting the phase of an output of the first optical amplifier by a predetermined amount, and the second modulator may include a second optical amplifier performing XPM on the continuous optical signal in response to the second optical signal.

The power of an input signal may be less than a predetermined level, the first and second optical amplifiers output the input signal without delaying the phase of the input signal, and when the power of the input signal is greater than the predetermined level, the first and second optical amplifiers delay the phase of the input signal by a predetermined amount.

When the power of the first optical signal is at a high level, the first optical amplifier may delay the phase of the continuous optical signal by π, when the power of the first optical signal is at a low level, the first optical amplifier may not delay the phase of the continuous optical signal, when the power of the second optical signal is at a high level, the second optical amplifier may delay the phase of the continuous optical signal by π, when the power of the second optical signal is at a low level, the second optical amplifier may not delay the phase of the continuous optical signal the first phase shifter shifts the phase of an output of the first optical amplifier by (2n+1)π, where n is an integer, a high level gain of the first optical amplifier may be equal to a high level gain of the second optical amplifier, and a low level gain of the first optical amplifier may be equal to a low level gain of the second optical amplifier.

The first phase shifter may include a third optical amplifier performing self-phase modulation (SPM) on the output of the first optical amplifier in response to the output of the first optical amplifier.

The second interferometer may include a third modulator phase modulating the continuous optical signal in response to the sum signal and outputting the continuous optical signal; and a fourth modulator amplifying and outputting the continuous optical signal. The second modulation signal may be obtained by summing outputs of the third and fourth modulators with each other.

The third modulator may include a fourth optical amplifier performing XPM on the continuous optical signal in response to the sum signal and a second phase shifter shifting the phase of an output of the fourth optical amplifier by a predetermined amount, and the fourth modulator may include a fifth optical amplifier amplifying by a predetermined gain and outputting the continuous optical signal.

When the power of the input signal is less than a predetermined level, the fourth optical amplifier may shift the phase of the input signal by a predetermined amount, and when the power of the input signal is greater than the predetermined level, the fourth optical amplifier may shift the phase of the input signal by a predetermined amount.

When power of the sum signal is at a high level, the fourth optical amplifier may delay the phase of the continuous optical signal by π, when the power of the sum signal is at a low level, the fourth optical amplifier may not delay the phase of the continuous optical signal, the second phase shifter may shift the phase of an output of the fourth optical amplifier by (2n)π, where n is an integer, high level gains of the first, second, and third optical amplifiers and a gain of the fourth optical amplifier may be equal to one another, and low level gains of the first, second, and third optical amplifiers may be equal to one another. The second modulation signal may be the result of a NOR operation performed on the first and second optical signals, and the sum signal may be the result of a NAND operation performed on the first and second optical signals.

When the power of the sum signal is at a high level, the fourth optical amplifier may delay the phase of the continuous optical signal by π, when the power of the sum signal is at a low level, the fourth optical amplifier may not delay the phase of the continuous optical signal, the second phase shifter may shift the phase of the output of the fourth optical amplifier by (2n+1)π, where n is an integer, high level gains of the first, second, and third optical amplifiers may be equal to one another, and low level gains of the first, second, and third optical amplifiers and a gain of the fourth optical amplifier may be equal to one another. The second modulation signal may be the result of an OR performed on the first and second optical signals.

The second phase shifter may include a sixth optical amplifier phase modulating the output of the fourth optical amplifier in response to the output of the fourth optical amplifier.

The first and second interferometers may be, for example, Mach-Zehnder interferometers (MZIs), Michelson interferometers, etc. Either interferometer may use the co-propagation method or the counter propagation method. When the co-propagation method is used, the optical logic element may further include a band pass filter for filtering the input optical signals from an output of the co-propagation interferometer to output only the modulation signal.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a schematic diagram of an XOR circuit realized by SOA-MZI;

FIGS. 2A and 2B illustrate graphs of characteristics of the SOAs shown in FIG. 1;

FIG. 3 illustrates a schematic diagram of an optical logic element according to an embodiment of the present invention;

FIG. 4 illustrates a schematic diagram of an optical logic element according to another embodiment of the present invention;

FIG. 5 illustrates a schematic diagram an optical logic element according to another embodiment of the present invention;

FIG. 6 illustrates a schematic diagram of an optical logic element according to another embodiment of the present invention; and

FIG. 7 illustrates a graph of results of an experiment performed with an optical logic element of an embodiment of the present invention.

### DETAILED DESCRIPTION OF THE INVENTION

Korean Patent Application No.10-2005-0099942, filed on Oct. 22, 2005, in the Korean Intellectual Property Office, and entitled: “Optical Logic Element,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In accordance with embodiments of the present invention, an optical logic element may be realized using all-optical XOR, NOR, OR, and NAND circuits. As a result, any desired optical logic element may be readily constructed.

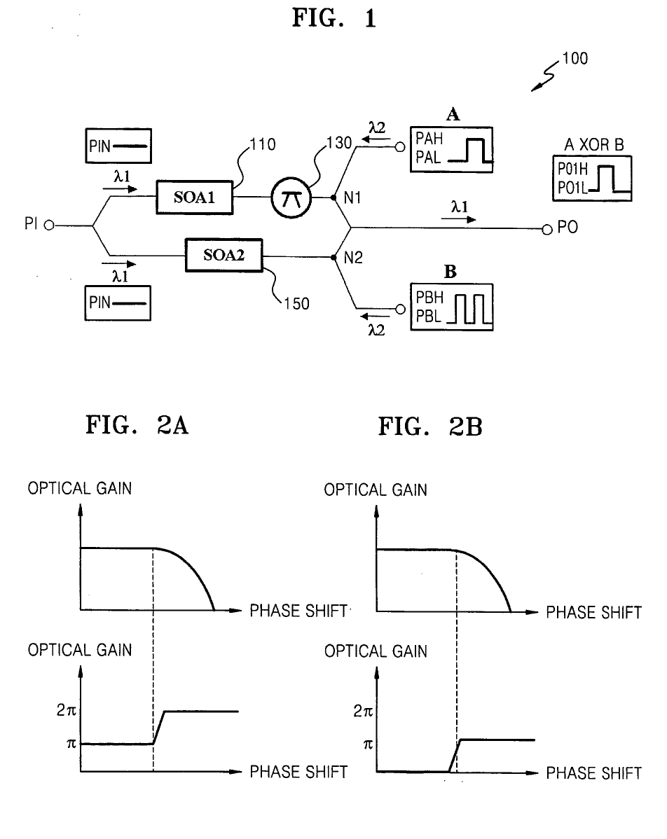

FIG. 1 illustrates a schematic diagram of an XOR circuit 100 realized by SOA-MZIs. Referring to FIG. 1, the XOR circuit 100 may include a first optical amplifier 110, a phase shifter 130, and a second optical amplifier 150. The first optical amplifier 110 may modulate a probe signal PI in response to a first optical signal A. The phase shifter 130 may shift a phase of an output signal of the first optical amplifier 110 by a predetermined value. The second optical amplifier 150 may modulate the probe signal PI in response to a second optical signal B.

Optical gains and phases of the first and second optical amplifiers 110 and 150 may vary non-linearly according to the power of an input signal. The first and second optical amplifiers 110 and 150 may perform XPM or XGM on the input signal according to their non-linear characteristics.

FIG. 2A illustrates a graph of a phase shift occurring in an upper arm of an MZI according to the non-linear characteristics of the first optical amplifier 110 of FIG. 1 with respect to the input power. FIG. 2B illustrates a graph of a phase shift occurring in a lower arm of the MZI according to the non-linear characteristics of the second optical amplifier 150 of FIG. 1 with respect to the input power.

As shown in FIGS. 2A and 2B, if the power of an input signal, i.e., the first optical signal A or the second optical signal B, is less than a predetermined value, the first and second optical amplifiers 110 and 150 have predetermined gains. However, if the power of the input signal is greater than the predetermined value, the gains of the first and second optical amplifiers 110 and 150 decrease with increasing power of the input signal.

If the power of the input signal is less than the predetermined value, the first and second optical amplifiers 110 and 150 do not delay the phase, i.e., the optical phase, of the input signal. Thus, the phase shift occurring in the upper arm is π, and the phase shift occurring in the lower arm is 0. However, if the power of the input signal is greater than the predetermined value, the first and second optical amplifiers 110 and 150 delay the phase of the input signal by π. Thus, the phase shift occurring in the upper arm is 2π, i.e., effectively zero, and the phase shift occurring in the lower arm is π.

The operation of the XOR circuit 100 will now be described in more detail with reference to FIGS. 1, 2A, and 2B.

The XOR circuit 100 may modulate a continuous optical signal PI in response to the first and second optical signals A and B, and sums modulated signals to perform an XOR operation on the first and second optical signals A and B.

The continuous optical signal PI may be a continuous waveform (CW) probe signal having a first wavelength λ1. The first and second optical signals A and B may be pump signals modulated into pulse wave signals to modulate the continuous optical signal PI, and having a second wavelength λ2.

For convenience, it is assumed that the first and second optical signals A and B are modulated to have “LLHH” and “LHLH” patterns, respectively. Here, “L” denotes a low level, and “H” denotes a high level.

The XOR circuit 100 may use an SOA-MZI having a counter-propagation method. Thus, the first and second optical signals A and B are input in an opposite direction to a direction along which the continuous optical signal PI is input.

As shown in FIG. 1, the upper arm may include the first optical amplifier 110 and the phase shifter 130, and the lower arm may include the second optical amplifier 150.

The phase shifter 130 of the XOR circuit shown in FIG. 1 may shift the phase of the output signal of the first optical signal 110 by (2n+1)π, i.e., effectively by π. Thus, a phase difference between the signals in the lower and upper arms may be π. This is to set a phase difference between signals at first and second nodes N1 and N2 to π on a low level of a pump signal so as to improve an extinction ratio (ER).

The first wavelength Al of the continuous optical signal PI is different from the second wavelength λ2 of the first and second optical signals A and B. Thus, the continuous optical signal PI and the first and second optical signals A and B do not affect one another and independently advance, except at the first and second optical amplifiers 110 and 150.

The operation of the XOR circuit 100 according to a detailed logic combination of the first and second optical signals A and B will now be described.

In the upper arm, the continuous optical signal PI may be modulated according to the first optical signal A. In other words, if the first optical signal A is at a low level, the first optical amplifier 110 does not delay the phase of the first optical signal A through XPM. Thus, the continuous optical signal PI is phase shifted by the phase shifter 130. Thus, a continuous optical signal phase shifted by π arrives at the first node N1.

If the first optical signal A is at a high level, the first optical amplifier 110 delays the phase of the first optical signal A by π through XPM. Thus, the continuous optical signal PI is phase delayed by the first optical amplifier 110 and phase shifted by the phase shifter 130. As a result, a continuous optical signal that is phase shifted by 2π, i.e., is effectively not phase shifted, arrives at the first node N1.

In the lower arm, the continuous optical signal PI may be modulated according to the second optical signal B. In other words, if the second optical signal B is at a low level, the second optical amplifier 150 does not delay the phase of the second optical signal B through XPM. Thus, a continuous optical signal that is not phase shifted arrives at the second node N2.

If the second optical signal B is at a high level, the second optical amplifier 150 delays the phase of the second optical signal B by π through XPM. Thus, the continuous optical signal PI is phase shifted by the second optical amplifier 150. As a result, a continuous optical signal phase shifted by π arrives at the second node N2.

Accordingly, continuous optical signals with different phases depending on the logic combination of the first and second optical signals A and B travel through the upper and lower arms. The continuous optical signals traveling through the upper and lower arms are summed. As a result, a result of performing a logic operation on the first and second optical signals A and B is output.

In detail, if the first and second optical signals A and B are both at a low level, the continuous optical signal phase shifted by π arrives at the first node N1 of the upper arm, but the continuous optical signal that is not phase shifted arrives at the second node N2 of the lower arm. Thus, the continuous optical signals in the upper and lower arms have a phase difference of π, and, thus, destructively interfere with each other. As a result, an output signal PO is at a low level.

If the first optical signal A is at a low level and the second optical signal B is at a high level, a continuous optical signal phase shifted by π arrives at the first node N1 of the upper arm, and a continuous optical signal phase shifted by π arrives at the second node N2 of the lower arm. Thus, the continuous optical signals in the upper and lower arms do not have a phase difference, and, thus, constructively interfere with each other. As a result, the output signal PO is at a high level.

If the first optical signal is at a high level and the second optical signal B is at a low level, a continuous optical signal phase shifted by 2π, i.e., not phase shifted, arrives at the first node N1 of the upper arm, and a continuous optical signal that has not been phase shifted arrives at the second node N2 of the lower arm. Thus, the continuous optical signals in the upper and lower arms do not have a phase difference, and thus constructively interfere with each other. As a result, the output signal PO is at a high level.

If the first and second optical signals A and B are both at a high level, a continuous optical signal phase shifted by 2π, i.e., not phase shifted, arrives at the first node N1 of the upper arm, and a continuous optical signal phase shifted by π arrives at the second node N2 of the lower arm. Thus, the continuous optical signals of the upper and lower arms have a phase different of π, and, thus, destructively interfere with each other. As a result, the output signal PO is at a low level.

As described above, the XOR circuit 100 shown in FIG. 1 outputs the result of an XOR operation on the first and second optical signals A and B.

An optical logic element according to an embodiment of the present invention will now be described with reference to the description of the XOR circuit 100 shown in FIG. 1.

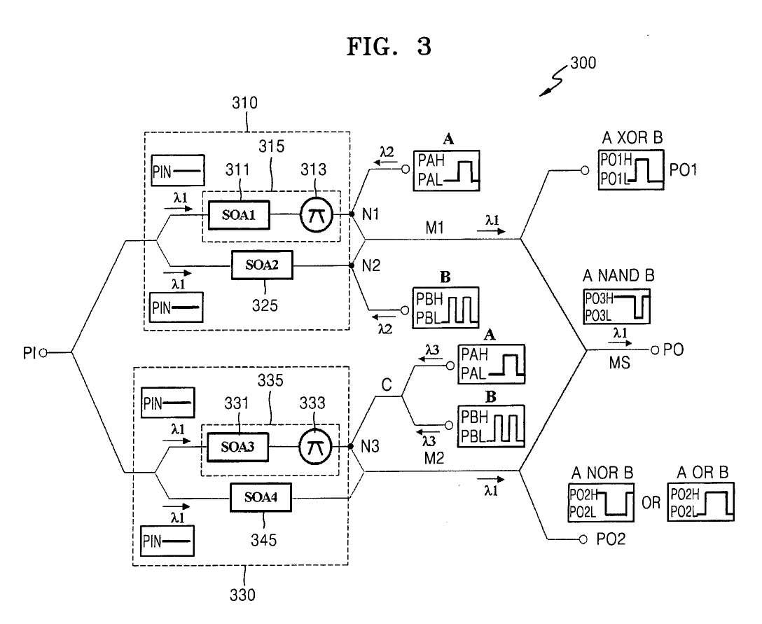

FIG. 3 illustrates a schematic diagram of an optical logic element 300 according to an embodiment of the present invention. Referring to FIG. 3, the optical logic element 300 may include first and second interferometers 310 and 330 using a counter-propagation method. Thus, a direction in which a continuous optical signal PI is input is opposite to a direction in which a first optical signal A, a second optical signal B, and a sum signal C equal to the sum of the first and second optical signals A and B are input.

Also, the wavelength λ1 of the continuous optical signal PI is different from the wavelength λ2 of the first and second optical signals A and B. The wavelength λ1 of the continuous optical signal PI is also different from a wavelength λ3 of the sum signal C of the first and second optical signals A and B. The wavelengths λ2 of the first and second optical signals A and B may be different from the wavelength λ3 of the sum signal C as shown in FIG. 3. However, although the wavelength λ2 is different than the wavelength λ3 in the present embodiment, the present invention is not limited to this.

The first interferometer 310 may modulate the continuous optical signal PI in response to the first and second optical signals A and B to output a first modulation signal M1. The second interferometer 330 may modulate the continuous optical signal PI in response to the sum signal C to output a second modulation signal M2.

The first modulation signal M1, the second modulation signal M2, and a sum signal MS, equal to the sum of the first and second modulation signals M1 and M2, may each be obtained through a predetermined logic operation performed on the first and second optical signals A and B. In other words, since the first interferometer 310 has the same structure as the XOR circuit 100 shown in FIG. 1, the first modulation signal Ml output from the first interferometer 310 may be the result of an XOR operation performed on the first and second optical signals A and B, i.e., M1=A XOR B.

The first interferometer 310 may include first and second modulators 315 and 325. The first modulator 315 phase may modulate and output the continuous optical signal PI in response to the first optical signal A. The second modulator 325 phase may modulate and output the continuous optical signal PI in response to the second optical signal B.

In other words, the first modulator 315 may output the continuous optical signal PI phase shifted by a predetermined amount to a first node N1, and the second modulator 325 may output the continuous optical signal phase PI shifted by a predetermined amount to a second node N2.

As shown in FIG. 3, the output signals of the first and second modulators 315 and 325 may be summed to generate the first modulation signal M1, and constructively or destructively interfere with each other according to the shifts in their phases.

The first modulator 315 may form an upper arm of the first interferometer 310, and the second modulator 325 may form a lower arm of the first interferometer 310. Phase shifts of the output signals of the first and second modulators 315 and 325 may be the same as in the XOR circuit 100 shown in FIG. 1.

The first modulator 315 may include a first optical amplifier 311 and a first phase shifter 313. The first optical amplifier 311 may perform XPM on the continuous optical signal PI in response to the first optical signal A. The first phase shifter 313 may shift the phase of an output signal of the first optical amplifier 311 by a predetermined amount.

The second modulator 325 may include a second optical amplifier 325 performing XPM on the continuous optical signal PI in response to the second optical signal B.

In the present embodiment, the first and second optical amplifiers 311 and 325 may have the characteristics described with reference to FIGS. 2A and 2B. In other words, if the power of an input signal (hereinafter referred to as “input power”) is less than a predetermined level, the first and second optical amplifiers 311 and 325 may output the input signal without delaying the phase of the input signal. If the input power is greater than the predetermined level, the first and second optical amplifiers 311 and 325 delay and output the phase of the input signal, by a predetermined amount. In the present embodiment, the predetermined amount may be π.

Accordingly, if the power of the first optical signal A is at a high level, the first optical amplifier 311 may delay the phase of the continuous optical signal PI by π. If the power of the first optical signal A is at a low level, the first optical amplifier 311 may not delay the phase of the continuous optical signal PI.

If the power of the second optical signal B is at a high level, the second optical amplifier 325 in the lower arm of the first interferometer 310 may delay the phase of the continuous optical signal PI by π. If the power of the second optical signal B is at a low level, the second optical amplifier 325 may not delay the phase of the continuous optical signal PI. Here, the first phase shifter 313 may shift the phase of an output signal of the first optical amplifier 311 by (2n+1)π, where n is an integer.

Under these conditions, the first interferometer 310 according to the present embodiment may perform the same operation as the XOR circuit 100 shown in FIG. 1. Thus, the first modulation signal M1 may be the result of an XOR operation performed on the first and second optical signals A and B.

Since the first interferometer 310 has the same structure as the XOR circuit 100 shown in FIG. 1 as described above, the detailed operation of the first interferometer 310 will not be described herein.

The second interferometer 330 may include third and fourth modulators 335 and 345. The third modulator 335 may phase modulate and output the continuous optical signal PI in response to the sum signal C. In other words, the third modulator 335 may output the continuous optical signal PI phase shifted by a predetermined amount to a third node N3. The fourth modulator 345 may amplify P1 by a predetermined gain and output the continuous optical signal PI.

As shown in FIG. 3, output signals of the third and fourth modulators 335 and 345 may be summed to generate a second modulation signal M2, and may constructively or destructively interfere with each other according to the shift in their phases. The third modulator 335 may form an upper arm of the second interferometer 330, and the fourth modulator 345 may form a lower arm of the second interferometer 330. The phase shifts of the output signals of the third and fourth modulators 335 and 345 may be the same as the phase shifts of the output signals of the first and second modulators 315 and 325.

The third modulator 335 may include a third optical amplifier 331 and a second phase shifter 333. The third optical amplifier 331 may phase modulate the continuous optical signal PI in response to the sum signal C. The second phase sifter 333 may phase shift an output signal of the third optical amplifier 331 by a predetermined value.

In the present embodiment, the second interferometer 330 may perform different logic operations according to a phase shift amount of the second phase shifter 333 in a similar manner to the first interferometer 310.

The fourth modulator 345 may be a fourth optical amplifier 345 amplifying by a predetermined gain and outputting the continuous optical signal PI. The fourth optical amplifier 345 may perform self-phase modulation (SPM) on the continuous optical signal PI. In the present embodiment, the fourth optical amplifier 345 does not shift the phase of the continuous optical signal PI.

As in the description of the XOR circuit 100 shown in FIG. 1, the first and second optical signals A and B may be optical pulse signals modulated into “LLHH” and “LHLH” signals, respectively. Thus, the sum signal C may have three levels, i.e., a low level (AB=“LL”), a first high level (AB=“LH” or AB=“HL”), and a second high level (AB=“HH”). Here, the first high level is less than the second high level.

In the present embodiment, the third optical amplifier 331 may have the characteristics described with reference to FIGS. 2A and 2B. In other words, if the input power is less than a predetermined level, the third optical amplifier 331 may output the input signal without delaying the phase of the input signal. If the input power is greater than the predetermined level, the third optical amplifier 331 may delay the phase of the input signal by a predetermined amount. In the present embodiment, the predetermined value may be π.

Thus, if the power of the sum signal C is at the low level, the third optical amplifier 331 may not delay the phase of the continuous optical signal PI. If the power of the sum signal C is at the first or second high level, the third optical amplifier 331 may delay the phase of the continuous optical signal PI by π.

The optical logic element 300 may perform a logic operation in accordance with the phase shift implemented by the second phase shifter 333. In detail, if the second phase shifter 333 shifts the phase of the output signal of the third optical amplifier 331 by π, the second interferometer 330 may perform an OR operation. If the second phase sifter 333 does not shift the phase of the output signal of the third optical amplifier 331, the second interferometer may perform a NOR operation. Another logic operation of the optical logic element 300 will now be described.

If the first and second optical signals A and B are both at a low level, the third optical amplifier 331 may not delay the phase of the continuous optical signal PI. However, the first optical signal A and/or the second optical signal B are at a high level, the third optical amplifier 331 may delay the phase of the continuous optical signal PI by π.

The fourth optical amplifier 345 may amplify the continuous optical signal PI by a predetermined gain and may output the amplified continuous optical signal PI regardless of the levels of the first and second optical signals A and B, and may not delay the phase of the continuous optical signal PI.

If the second phase shifter 333 shifts the phase of the output signal of the third optical amplifier 331 by (2n)π, i.e., effectively does not shift the phase of the output signal of the third optical amplifier 331, the optical logic element 300 will perform the following operation.

If the first and second optical signals A and B are both at a low level, a continuous optical signal that is not phase shifted is output to a third node N3. Thus, continuous optical signals in the upper and lower arms of the second interferometer 330 do not have a phase difference, and thus constructively interfere with each other. As a result, the second modulation signal M2 is at a high level.

If the first optical signal A and/or the second optical signal B are at a high level, a continuous optical signal phase shifted by π is output to the third node N3. The continuous optical signals in the upper and lower arms of the second interferometer 330 have a phase difference of π, and, thus, destructively interfere with each other. As a result, the second modulation signal M2 is at a low level.

If the second phase shifter 333 shifts the phase of the output signal of the third optical amplifier 331 by (2n)π, the second modulation signal M2 is the result of an NOR operation performed on the first and second optical signals A and B.

The result of the NOR operation can be added to the result of an XOR operation to obtain a result of an NAND operation. Thus, the sum signal MS equal to the sum of the first and second modulation signals Ml and M2 is the result of an NAND operation.

If the second phase shifter 333 shifts the phase of the output signal of the third optical amplifier 331 by (2n)π, the optical logic element 300 according to the present embodiment may perform an XOR operation (the first modulation signal M1), a NOR operation (the second modulation signal M2), and a NAND operation (the sum signal MS of the first and second modulation signals M1 and M2) on the first and second optical signals A and B.

If the second phase shifter 333 shifts the phase of an output of the fourth optical amplifier by (2n+1)π, i.e., effectively by π, the optical logic element 300 may perform the following operation.

If the first and second optical signals A and B are both at a low level, a continuous optical signal phase shifted by π is output to the third node N3. Thus, the continuous optical signals in the upper and lower arms of the second interferometer 330 have a phase difference of π, and thus destructively interfere with each other. As a result, the second modulation signal M2 is at a low level.

If the first optical signal A and/or the second optical signal B are at a high level, a continuous optical signal that is not phase shifted is output to the third node N3. Thus, the continuous optical signals in the upper and lower arms of the second interferometer 330 do not have a phase difference, and, thus, constructively interfere with each other. As a result, the second modulation signal M2 is at a high level.

If the second phase shifter 333 shifts the phase of the output signals of the third optical amplifier 331 by (2n+1)π, the second modulation signal M2 is a result of an OR operation performed on the first and second optical signals A and B. In other words, the optical logic element 300 according to the present embodiment may perform an XOR operation (the first modulation signal M1) and an OR operation (the second modulation signal M2) on the first and second optical signals A and B.

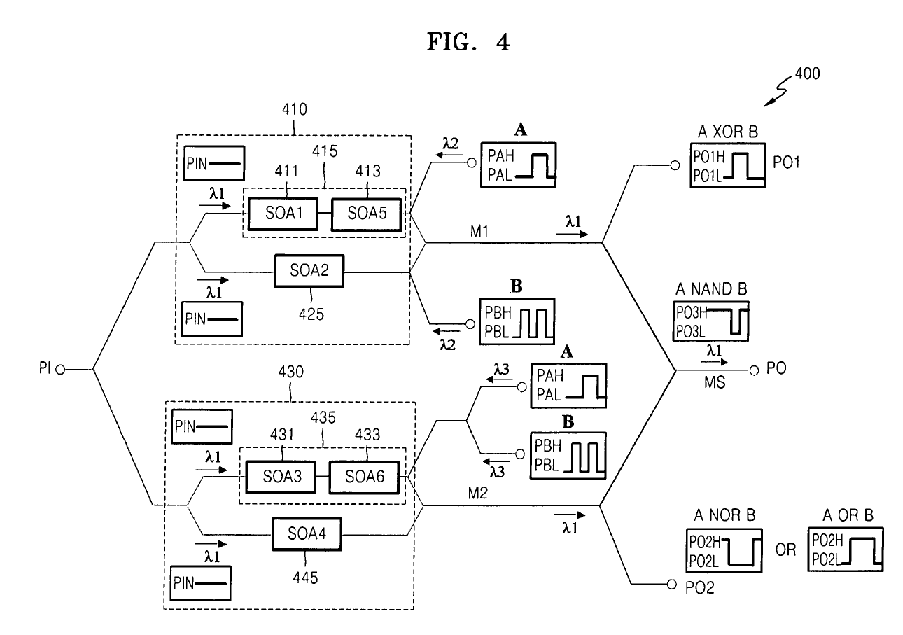

FIG. 4 illustrates a schematic diagram of an optical logic element 400 according to another embodiment of the present invention. Referring to FIG. 4, the optical logic element 400 may be the same as the optical logic element 300 shown in FIG. 3, except that the optical logic element 400 may include fifth and sixth optical amplifiers 413 and 433 serving as the first and second phase shifters. Like reference numerals in FIG. 4 are the same as those in FIG. 3.

In detail, the fifth optical amplifier 413 may perform SPM on an output signal of a first optical amplifier 411 in response to the output signal of the first optical amplifier 411. The sixth optical amplifier 433 may perform SPM on an output signal of a third optical amplifier 431 in response to the output signal of the third optical amplifier 431.

In the present embodiment, the fifth optical amplifier 413 may delay the phase of the output signal of the first optical amplifier 411 by a predetermined amount, e.g., by (2n+1)π, i.e., effectively by π. The sixth optical amplifier 433 may delay a phase of the output signal of the fourth optical amplifier 431 by a predetermined amount, e.g., by (2n+1)π or (2n)π, i.e., effectively by π or 0.

The optical logic element 400 shown in FIG. 4 may have the same structure and performs the same operations as the optical logic element 300 shown in FIG. 3, except that the fifth and sixth optical amplifiers are used in place of the first and second phase shifters 313 and 333 of the optical logic element 300. Thus, the structure and detailed operation of the optical logic element 400 will not be described herein.

In the optical logic element 400 shown in FIG. 4, a first optical signal A, a second optical signal B, and a sum signal C equal to the sum of the first and second optical signals A and B, may be directly input to the first optical amplifier 411, a second optical amplifier 425, and to the third optical amplifier 431, respectively, so as to prevent the first and second optical signals A and B and the sum signal C from being distorted by the fifth and sixth optical amplifiers 413 and 433.

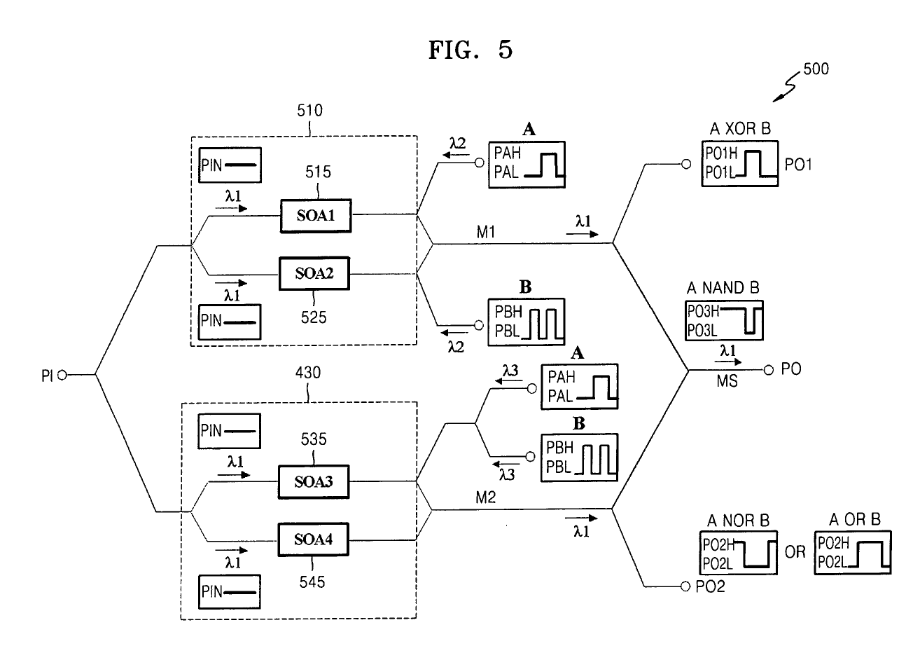

FIG. 5 illustrates a schematic diagram of an optical logic element 500 according to another embodiment of the present invention.

The optical logic element 500 shown in FIG. 5 may have the same structure as the optical logic element 300 shown in FIG. 3, except that the first optical amplifier 311 and the first phase shifter 313 may be integrated into a first modulator 515, and the third optical amplifier 331 and the second phase shifter 333 may be integrated into a third modulator 535.

In detail, a first interferometer 510 of the optical logic element 500 may include first and second modulators 515 and 525, which may be optical amplifiers, and a second interferometer may include third and fourth modulators 535 and 545, which may be optical amplifiers. Thus, the first modulator 515 may include a first optical amplifier, and the third modulator 535 may include a second optical amplifier.

The first optical amplifier in the first modulator 515 may perform XPM on a continuous optical signal PI in response to a first optical signal A, and then may delay the phase of the continuous optical signal PI by a predetermined amount. The third modulator 535 may perform XPM on the continuous optical signal PI in response to a sum signal C equal to the sum of the first optical signal A and a second optical signal B, and then may delay the phase of the continuous optical signal PI by a predetermined amount.

The operation of the optical logic element 500 is the same as that of the optical logic element 300 shown in FIG. 3, except that both XPM and phase shifting are performed by modulators 515 and 535, and thus will not be described herein.

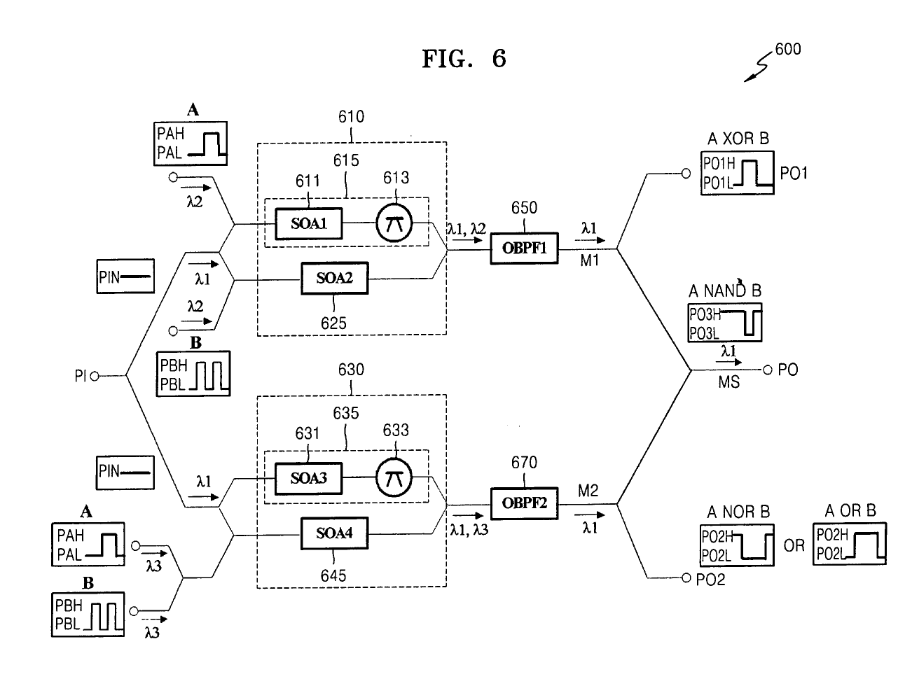

FIG. 6 illustrates a schematic diagram of an optical logic element 600 according to another embodiment of the present invention. The optical logic elements 300, 400, and 500 shown in FIGS. 3, 4, and 5 use interferometers using a counter-propagation method, while the optical logic element 600 uses an interferometer using a co-propagation method.

In other words, as shown in FIG. 6, first and second optical signals A and B, a sum signal C equal to the sum of the first and second optical signals A and B, and a continuous optical signal PI may be input to the logic element 600 in the same direction.

In the optical logic element 600, continuous optical signals modulated by first and second modulators 615 and 625 interfere with each other to generate a first modulation signal M1, and continuous optical signals modulated by third and fourth modulators 635 and 645 interfere with each other to generate a second modulation signal M2. Thus, the optical logic element 600 needs to filter the first and second optical signals A and B, and the sum signal C, from the signals output from a first interferometer 610 and a second interferometer 630.

Accordingly, unlike the optical logic elements 300, 400, and 500 shown in FIGS. 3, 4, and 5, the optical logic element 600 further includes first and second band pass filters 650 and 670. The first band pass filter 650 filters the first and second optical signals A and B outputs from the first interferometer 610 to output a first modulation signal M1. The second band pass filter 670 filters the sum signal C output from the second interferometer 630 to output a second modulation M2.

The optical logic element 600 has the same structure and performs the same operations as the optical logic element 300 shown in FIG. 3 except that the optical logic element 600 further includes the first and second band pass filters 650 and 670. Thus, the detailed operation of the optical logic element 600 will not be described herein.

As described above, an optical logic element according to an embodiment of the present invention uses an MZI. However, the present invention may be realized using an interferometer having the same characteristics as a Michelson interferometer or the like by those of ordinary skill in the art.

Optimal operating conditions for an optical logic element according to an embodiment of the present invention will now be described based on the optical logic element 300 shown in FIG. 3. The following description is related to optimal operating conditions of an optical logic element according to an embodiment of the present invention, and the operation of the optical logic element is not limited to the optimal operation conditions.

In the first interferometer 310, the power of the continuous optical signal PI is defined as PIN, high and low levels of power of the first optical signal A are respectively defined as PAL and PAH, and high and low levels of power of the second optical signal B are respectively defined as PBL and PBH. Optical gains of the first optical signal A and the continuous optical signal PI, i.e., PIN+PAL and PIN+PAH, obtained through the first optical amplifier 311 are respectively defined as G1L and G1H, and optical gains the second optical signal B and the continuous optical signal PI, i.e., PIN+PBL and PIN+PBH, obtained through the first optical amplifier 311 are respectively defined as G2L and G2H.

Thus, the first modulation signal M1 is obtained by combining signals with powers of PING1L and PING1H with signals with powers of PING2L and PING2H. XPM performed by optical amplifiers is mainly performed on an input signal at a high level. Thus, a power PO1-AB of the first modulation signal Ml can be represented by Equation 1:

$${P}_{01 - AB} = {P}_{in} ( {G}_{1 A} + {G}_{2 B} + \sqrt[2]{{G}_{1 A} \cdot {G}_{2 B}} cos ( {ϕ}_{1} + Δ {ϕ}_{XPM} ) ) \qquad ( 1 )$$

where φ1 is a phase difference between the signals in the upper and lower arms of the first interferometer 310, i.e., a phase difference produced by the first phase shifter 313, ΔφXPM is a phase difference between the signals in the upper and lower arms due to XPM, i.e., a difference between a phase shift ΔφXPM1 occurring due to XPM performed by the first optical amplifier 311 and a phase shift ΔφXPM2 due to XPM performed by the second optical amplifier 325, and G1A and G1B are optical gains provided by the first and second optical amplifiers 311 and 325, respectively.

If AB=“LL,” G1L and G2L both may have large values, and A(PXPM may have a value approximately equal to “0.” If AB=“LH” or AB=“HL,” one of G1A and G2B may have a large value, the other one may have a small value, and ΔφXPM may have a value approximately equal to “π.” If AB=“HH,” G1H and G2H may both have small values, and ΔφXPM may have a value approximately equal to “0.”

Four levels exist at φ1=0. The four levels are a PO1-LL((φ1=0) level having a maximum value due to ΔφXPM approximately equal to “0” on a curve of PO1-LL, i.e., if AB=“LL,” with respect to (φ1, a PO1-LH((φ1=0) level inside a curve of PO1-LH, i.e., if AB=“LH” with respect to φ1, a PO1-HL(φ1=0) level inside a curve of PO1-HL, i.e., if AB=“HL” with respect to φ1, and a PO1-HH((φ1=0) level inside a curve of PO1-HH, i.e., if AB=“HH” with respect to φ1. Four levels exist at φ1=π. The four levels are a PO1-LL((φ1=π) level having a minimum value due to ΔφXPM approximately equal to “0” on a curve of PO1-LL with respect to φ1, a PO1-LH(φ1=π) level inside a curve of PO1-LH with respect to φ1, a PO1-HL(φ1=π) level inside a curve of PO1-HL with respect to φ1, and a PO1-HH(φ1=π) level inside a curve of PO1-HH with respect to φ1.

Here, if six values of PO1-LL(φ1=0), PO1-LL(φ1=π), PO1-LH(φ1=0), PO1-LH(φ1=π), PO1-HL(φ1=0), and PO1-HL(φ1=π) inside curves PO1-AB(φ1=0) and PO1-AB(φ1=π) are checked, the six values are substituted for Equation 1 so as to obtain values of PING1L, PING2L, PING1H, PING2H, ΔφXPM1, and ΔφXPM2 that can be expressed as in Equations 2 through 5:

$$\begin{matrix}{P}_{in} {G}_{1 L} = {( \sqrt{{P}_{O 1 - II} ( ϕ = 0 )} \pm \sqrt{{P}_{O 1 - LL} ( ϕ = π )} )}^{2} / 4 , \\ {P}_{in} {G}_{2 L} = {( \sqrt{{P}_{O 1 - LL} ( ϕ = 0} ∓ \sqrt{{P}_{O 1 - LL} ( ϕ = π )} )}^{2} / 4 \\ {}^{*} upper sign \text{:} \sqrt{ {G}_{ 1 L}} \geq \sqrt{ {G}_{ 2 L}} , \\ lower sign \text{:} \sqrt{{G}_{1 L}} \leq \sqrt{{G}_{2 L}} & ( 2 ) \\ {P}_{in} {G}_{1 H} = - {P}_{in} {G}_{2 L} + ( {P}_{O 1 - HL} ( ϕ = 0 ) + {P}_{O 1 - HL} ( {ϕ}_{1} = π ) ) / 2 , \\ {P}_{in} {G}_{2 H} = - {P}_{in} {G}_{1 L} + ( {P}_{O 1 - LH} ( {ϕ}_{1} = 0 ) + {P}_{O 1 - LH} ( ϕ = π ) ) / 2 & ( 3 ) \\ \begin{matrix}Δ {ϕ}_{XPM 1} = {cos}^{- 1} [ \frac{{P}_{O 1 - HL} ( ϕ = 0 ) - {P}_{in} {G}_{1 H} - {P}_{in} {G}_{2 L}}{2 {P}_{in} \sqrt{{G}_{1 H} \cdot {G}_{2 L}}} ] \\ = cos [ \frac{{p}_{O 1 - HL} ( ϕ = π ) - {P}_{in} {G}_{1 H} - {P}_{in} {G}_{2 L}}{- 2 {P}_{in} \sqrt{{G}_{1 H} \cdot {G}_{2 L}}} ]\end{matrix} & ( 4 ) \\ \begin{matrix}Δ {ϕ}_{XPM 2} = {cos}^{- 1} [ \frac{{P}_{O 1 - LH} ( ϕ = 0 ) - {P}_{in} {G}_{1 L} - {P}_{in} {G}_{2 H}}{2 {P}_{in} \sqrt{{G}_{1 L} \cdot {G}_{2 H}}} ] \\ = cos [ \frac{{p}_{O 1 - LH} ( ϕ = π ) - {P}_{in} {G}_{1 L} - {P}_{in} {G}_{2 H}}{- 2 {P}_{in} \sqrt{{G}_{1 L} \cdot {G}_{2 H}}} ]\end{matrix} & ( 5 )\end{matrix}$$

An optimal optical gain and optical phase difference for operating an optimal operation of the first interferometer 310 may be obtained using Equations 2 through 5. The results of the optimal optical gain and phase difference are shown in Tables 1 and 2.

In the second interferometer 330, optical gains the first optical signal A and the continuous optical signal PI, i.e., PIN+PAL+PBL, PIN+PAL+PBH or PIN+PAH+PBL, and PIN+PAH+PBH, experienced in the third optical amplifier 331 may be defined as G3LL, G3LH or G3HL, and G3HH, and an optical gain the continuous optical signal PI, i.e., PIN, experienced in the fourth optical amplifier 345, may be defined as G4.

Thus, the second modulation signal M2 is a signal obtained by combining and interfering level signals of PING3LL, PING3LH or PING3HL, and PING3HH with a level signal of PING4. Since XPM performed by the third optical amplifier 311 vary with each level, a power PO2-AB of the second modulation signal M2 can be induced as in Equation 6:
P_{02-AB}Pᵢₙ(G_{3AB}+G₄+2\sqrt{G_{3AB}·G₄} cos(φ₂+Δφ_{XPM}) (6)

where φ₂ is a phase difference between the upper and lower arms of the second interferometer 330, i.e., a phase difference by the second phase shifter 333, Δφ_{XPM} is a difference between a phase shift between the upper and lower arms due to XPM, i.e., a phase shift Δφ_{XPM3} due to XPM performed by the third optical amplifier 331, a phase shift Δφ_{XPM4} due to XPM performed by the fourth optical amplifier 345, and G_{3AB} and G₄ respectively are optical gains in the third and fourth optical amplifiers 331 and 345. As described above, in the present embodiment, Δφ_{XPM4}=0, particularly, G₄ may be controlled so as to control a gain difference between the third and fourth optical amplifiers.

If AB=“LL”, G_{3LL} (hereinafter referred to as G_{3L}) may have a large value, and Δφ_{XPM} may have a value approximately equal to 0. If AB=“LH” or “HL,” G_{3LH} and G_{3HL} may be expressed as G_{3H} having a small value, and Δφ_{XPM} may have a value approximately equal to π. If AB=“HH,” G_{3HH} may have a very small value, and Δφ_{XPM} may have a value approximately equal to π.

Four levels exist at φ₂=0. The four levels are a P_{O2-LL}(φ2=0) level having a maximum value on a curve of P_{O2-LL} with respect to φ₂ due to Δφ_{XPM} being approximately equal to 0, a P_{O2-LH}(φ2=0) level inside a curve of P_{O2-LH} with respect to φ2, a P_{O2-HL}(φ2=0) level inside a curve of PO2-HL with respect to φ2 and a P_{O2-HH}(φ2=0) level inside a curve of PO2-HH with respect to φ₂.

Also, four levels exist at φ₂=π. The four levels are a P_{O2-LL}(φ₂=π) level having a minimum value on a curve of P_{O2-LL} with respect to φ₂ due to Δφ_{XPM} being approximately equal to 0, a P_{O2-LH}(φ2=π) level inside a curve of P_{O2-LH} with respect to φ₂, a P_{O2-HL}(φ₂=π) inside a curve of P_{O2-HL} with respect to φ₂, and a P_{O2-HH}(φ₂=π) level inside a curve of P_{O2-HH} with respect to φ₂.

Here, if the P_{O2-LL}(φ₂=0), P_{O2-LL}(φ₂=π), P_{O2-LH}(φ₂=0) or P_{O2-HL}(φ₂=0), P_{O2-LH}(φ₂=π) or P_{O2-HL}(φ₂=π), P_{O2-HH}(φ₂=0), and P_{O2-HH}(φ₂=π) levels are checked inside curves of P_{O2-AB}(φ₂=0) and P_{O2-AB}(φ₂=π), the six levels may be substituted into Equation 6 to obtain values of PING_{3L}, PING_{3H}, PING_{3HH}, PING₄, Δφ_{XPM3H}, and Δφ_{XPM3HH}, which may be given by Equations 7 through 10:

$$\begin{matrix}{P}_{in} {G}_{3 L} = {( \sqrt{{P}_{O 2 - LL} ( {ϕ}_{2} = 0 )} \pm \sqrt{{P}_{O 2 - LL} ( {ϕ}_{2} = π )} )}^{2} / 4 , \\ {P}_{in} {G}_{4} = {( \sqrt{{P}_{O 2 - LL} ( {ϕ}_{2} = 0} ∓ \sqrt{{P}_{O 2 - LL} ( {ϕ}_{2} = π )} )}^{2} / 4 \\ {}^{*} upper sign \text{:} \sqrt{ {G}_{ 3 L}} \geq \sqrt{ {G}_{ 4}} , \\ lower sign \text{:} \sqrt{{G}_{3 L}} \leq \sqrt{{G}_{4}} & ( 7 ) \\ {P}_{in} {G}_{3 H} = - {P}_{in} {G}_{4} + ( {P}_{O 2 - LH} ( {ϕ}_{2} = π ) ) / 2 , \\ {P}_{in} {G}_{3 HH} = - {P}_{in} {G}_{4} + ( {P}_{O 2 - HH} ( {ϕ}_{2} = 0 ) + {P}_{O 2 - HH} ( {ϕ}_{2} = π ) ) / 2 & ( 8 ) \\ \begin{matrix}Δ {ϕ}_{XPM 3 H} = {cos}^{- 1} [ \frac{{P}_{O 2 - LH} ( {ϕ}_{2} = 0 ) - {P}_{in} {G}_{3 H} - {P}_{in} {G}_{4}}{2 {P}_{in} \sqrt{{G}_{3 H} \cdot {G}_{4}}} ] \\ = {cos}^{- 1} [ \frac{{P}_{O 2 - LH} ( {ϕ}_{2} = π ) - {P}_{in} {G}_{3 H} - {P}_{in} {G}_{4}}{- 2 {P}_{in} \sqrt{{G}_{3 H} \cdot {G}_{4}}} ]\end{matrix} & ( 9 ) \\ \begin{matrix}Δ {ϕ}_{XPM 3 HH} = {cos}^{- 1} [ \frac{{P}_{O 2 - HH} ( {ϕ}_{2} = 0 ) - {P}_{in} {G}_{3 HH} - {P}_{in} {G}_{4}}{2 {P}_{in} \sqrt{{G}_{3 HH} \cdot {G}_{4}}} ] \\ = {cos}^{- 1} [ \frac{{P}_{O 2 - HH} ( {ϕ}_{2} = π ) - {P}_{in} {G}_{3 HH} - {P}_{in} {G}_{4}}{- 2 {P}_{in} \sqrt{{G}_{3 HH} \cdot {G}_{4}}} ]\end{matrix} & ( 10 )\end{matrix}$$

Optimal optical gains and phase differences for the optimal operation of the second interferometer 330 can be obtained from Equations 7 through 10 and are shown in Tables 1 and 2.

TABLE 1

| | | XOR(φ₁ = π) | | NOR(φ₂ = 0) | | OR(φ₂ = π) | | NAND(=XOR + NOR) | |
|---|---|---|---|---|---|---|---|---|---|
| A | B | O | P_{O1}(φ₁ = π) | O | P_{O2}(φ₂ = 0) | O | P₀₂(φ₂ = π) | O | P₀₃ = P_{O1}(φ₁ = π) + p₀₂((φ₁ = π) |
| L | L | L | 0 | H | c + f + 2\sqrt{(cf)} | L | c + f − 2\sqrt{(cf)} | H | c + f − 2\sqrt{(cf)} |
| L | H | H | a + b + 2\sqrt{(ab)} | L | d + f − 2\sqrt{(df)} | H | d + f + 2\sqrt{(df)} | H | a + b + 2\sqrt{(ab)} + d + f − 2\sqrt{(df)} |
| H | L | H | a + b + 2\sqrt{(ab)} | L | d + f − 2\sqrt{(df)} | H | d + f + 2\sqrt{(df)} | H | a + b + 2\sqrt{(ab)} + d + f − 2\sqrt{(df)} |
| H | H | L | 0 | L | e + f − 2\sqrt{(ef)} | H | e + f + 2\sqrt{(ef)} | L | e + f − 2\sqrt{(ef)} |

TABLE 2

| | | | | XOR(φ ₂ = π) | | XOR(φ₂ = 0) | | OR(φ₂ = π) c = f, | | NAND | |
|---|---|---|---|---|---|---|---|---|---|---|---|
| | | Δφ_{XPM} | Δφ_{XPM} | a = c, b = d | | d = f ≈ e | | d ≈ e | | (=XOR + NOR) | |
| A | B | (XOR) | (NOR/OR) | O | P_{O1}(φ₁ = π) | O | P_{O2}(φ₂ = 0) | O | P_{O2}(φ₂ = π) | O | P₀₃ |
| L | L | 0 | 0 | L | 0 | H | c + d + 2\sqrt{(cd)} | L | 0 | H | c + d + 2\sqrt{(cd)} |
| L | H | π | π | H | c + d + 2\sqrt{(cd)} | L | 0 | H | d + f + 2\sqrt{(df)} | H | c + d + 2\sqrt{(cd)} |
| H | L | π | π | H | c + d + 2\sqrt{(cd)} | L | 0 | H | d + f + 2\sqrt{(df)} | H | c + d + 2\sqrt{(cd)} |
| H | H | 0 | π | L | 0 | L | ≈0 | H | ≈d + f + 2\sqrt{(df)} | L | ≈e |

For convenience, PING_{1L}=PING_{2L}=a, PING_{1H}=PING_{2H}=b, PING_{3L}=c, PING_{3H}=d, PING_{3HH}=e, and PING₄=f. Also, it is assumed that a phase shift caused by XPM is π at a high level and 0 at a low level.

In the present embodiment, gains and phase differences between upper and lower arms of first and second interferometers can be adjusted so as to optimally operate an optical logic element.

In other words, a gain and a phase difference may be optimized so as to realize an optical logic element capable of performing XOR, NOR, OR, and NAND operations.

Bias currents of optical amplifiers and control voltages of phase shifters can be adjusted by those of ordinary skill in the art so as to easily adjust a gain and phase difference.

Also, an extinction ratio (ER) may be expressed as in Equation 11:
ER=10 log(high state level/low state level) (11)

In the present embodiment, a maximum ER can be obtained through the following process.

Combinations of bias currents of the first, second, third, and fourth optical amplifiers 311, 325, 331, and 345 are set at appropriate resolutions below a maximum value.

If all combinations of bias currents are applied to the first and second optical amplifiers 311 and 325 of the first interferometer 310, P_{O1-LL}(φ₁=0), P_{O1-LL}(φ₁=π), P_{O1-LH}(φ₁=0), P_{O1-LH}(φ₁=π), P_{O1-HL}(φ₁=0), and P_{O1-HL}(φ₁=π) levels may be measured. If all combinations of bias currents are applied to the third and fourth optical amplifiers 331 and 345 of the second interferometer 330, P_{O2-LL}(φ₂=0), P_{O2-LL}(φ₂=π), P_{O2-LH}(φ₂=0) or P_{O2-HL}(φ₂=0), P_{O2-LH}(φ₂=π) or P_{O2-HL}(φ₂=π), P_{O2-HH}(φ₂=0), and P_{O2-HH}(φ₂=π) levels may be measured.

Values of PING_{1L}, PING_{2L}, PING_{1H}, PING_{2H}, Δφ_{XPM1}, and Δφ_{XPM2} are calculated with respect to the first interferometer 310, and combinations of optical bias currents satisfying gain conditions of PING_{1L}=PING_{2L}=PING_{3L} and PING_{1H}=PING_{2H}=PING_{3H} may be obtained. Values of PING_{3L}, PING_{3H}, PING_{3HH}, PING₄, Δφ_{XPM3H}, and Δφ_{XPM3HH} of the second interferometer 310 may be calculated, and combinations of optimal bias currents satisfying PING_{3H}=PING₄≈. PING_{3HH} and conditions of PING_{3L}=PING₄ and PING_{3H}≈PING_{3HH} with respect to XOR and OR operations may be obtained.

As described above, combinations of optical bias currents may be obtained so as to obtain an optimal ER.

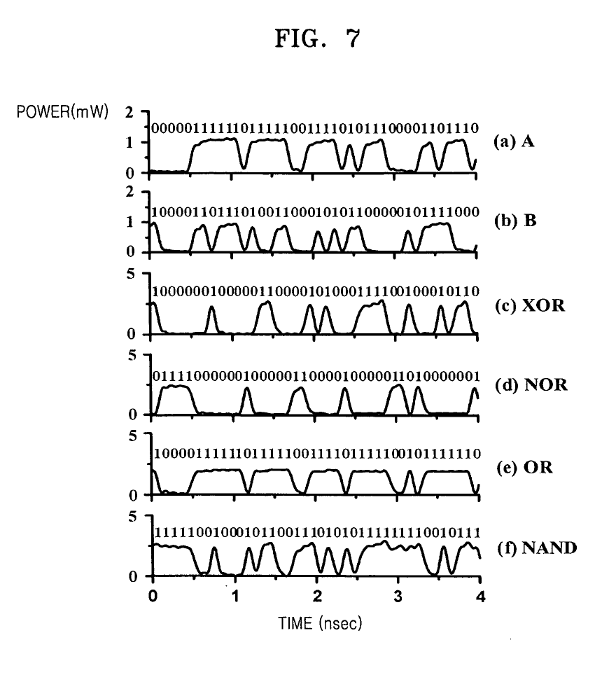

FIG. 7 illustrates a timing diagram of results of an experiment performed on an optical logic element according to an embodiment of the present invention, i.e., FIGS. 7(c), 7(d), 7(e), and 7(f) respectively illustrate the results of XOR, NOR, OR, and NAND operations on first and second optical signals A and B shown in FIGS. 7(a) and 7(b).

In the experiment, a continuous optical signal PI was generated using a tunable laser diode (LD) having a wavelength of 1549.79 nm. Also, a distributed feedback (DFB) LD1 having a wavelength of 1551.47 nm was used to generate the first and second optical signals A and B input to a first interferometer, and a DFB LD2 having a wavelength of 1553.79 nm was used to generate a sum signal C equal to the sum of the first and second optical signals A and B.

In the experiment, a pulse pattern generator (PPG) was used to program the first and second optical signals A and B and the sum signal C with a repeating pattern of “00001111” at a speed of 2.5 Gbps so as to directly modulate the first and second signals A and B and the sum signal C with the DFB LD1 and DFB LD2.

To generate the first and second optical signals A and B in the first interferometer, an optical divider was used to divide an optical signal modulated in a repeated pattern into two signals and transmit one of the two signals through a time delay line corresponding to a half period of a total signal pattern so that combinations of the first and second optical signals A and B were repeated as “LL,” “LH,” “HL,” and “HH.”

In the second interferometer, an output of the DFB LD2 passed through an additional MZI, and a time delay line corresponding to a half period of a total signal pattern was inserted in the middle of an arm of the additional MZI so as to output a sum signal equal to the sum of first and second optical signals having combinations of “LL,” “LH,” “HL,” and “HH.”

As shown in FIG. 7(c), when a phase shift of a first phase shifter was π, the output of the first interferometer was an XOR operation on the first and second optical signals A and B.

As shown in FIG. 7(d), when a phase shift of a second phase shifter was 0, the output of the second interferometer was an XOR operation on the first and second optical signals A and B.

As shown in FIG. 7(e), when the phase shift of the second phase shifter was π, the output of the second interferometer was an OR operation on first and second optical signals.

As shown in FIG. 7(f), when the phase shifter value of the first phase shifter was π and the phase shift of the second phase shifter was 0, the outputs of the first and second interferometers were NAND operations on the first and second optical signals.

As described above, an optical logic element according to the present invention can realize all-optical XOR, NOR, OR, and NAND circuits. As a result, the optical logic element can be easily realized by realizing the all-optical NOR or NAND circuit. Also, optimal operation conditions can be obtained for the optical logic element so as to maximize an ER and minimize a bit error rate.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An optical logic element performing a logic operation on optical signals using an interferometer using a counter-propagation method, comprising:
a first interferometer for modulating a continuous optical signal in response to first and second optical signals to output a first modulation signal; and
a second interferometer for modulating the continuous optical signal in response to a sum signal equal to the sum of the first and second optical signals to output a second modulation signal,
wherein the first and second modulation signals and a sum signal of the first and second modulation signals are respectively results of predetermined logic operations performed on the first and second optical signals.

2. The optical logic element as claimed in claim 1, wherein the first interferometer comprises:
a first modulator phase modulating the continuous optical signal in response to the first optical signal to output the phase modulated continuous optical signal; and
a second modulator phase modulating the continuous optical signal in response to the second optical signal to output the phase modulated continuous optical signal,
wherein the first modulation signal is obtained by summing outputs of the first and second modulators.

3. The optical logic element as claimed in claim 2, wherein:
the first modulator includes
a first optical amplifier performing cross phase modulation (XPM) on the continuous optical signal in response to the first optical signal; and
a first phase shifter shifting the phase of an output of the first optical amplifier by a predetermined amount; and
the second modulator includes
a second optical amplifier performing XPM on the continuous optical signal in response to the second optical signal.

4. The optical logic element as claimed in claim 3, wherein, when the power of an input signal is less than a predetermined level, the first and second optical amplifiers present no effective delay to the phase of the input signal, and when the power of the input signal is greater than the predetermined level, the first and second optical amplifiers delay the phase of the input signal by a predetermined amount.

5. The optical logic element as claimed in claim 4, wherein, when the power of the first optical signal is at a high level, the first optical amplifier delays the phase of the continuous optical signal by π, when the power of the first optical signal is at a low level, the first optical amplifier does not delay the phase of the continuous optical signal,
when the power of the second optical signal is at a high level, the second optical amplifier delays the phase of the continuous optical signal by π, when the power of the second optical signal is at a low level, the second optical amplifier does not delay the phase of the continuous optical signal,
the first phase shifter shifts the phase of an output of the first optical amplifier by (2n+1)π, where n is an integer, and
a high level gain of the first optical amplifier is equal to a high level gain of the second optical amplifier, and a low level gain of the first optical amplifier is equal to a low level gain of the second optical amplifier.

6. The optical logic element as claimed in claim 5, wherein the first modulation signal is a result of an XOR operation performed on the first and second optical signals.

7. The optical logic element as claimed in claim 3, wherein the first phase shifter comprises a third optical amplifier performing self-phase modulation (SPM) on the output of the first optical amplifier in response to the output of the first optical amplifier.

8. The optical logic element as claimed in claim 7, wherein the first optical signal is directly input to the first optical amplifier.

9. The optical logic element as claimed in claim 2, wherein the second interferometer comprises:
a third modulator phase modulating the continuous optical signal in response to the sum signal and outputting the phase modulated continuous optical signal; and
a fourth modulator amplifying the continuous optical signal and outputting the amplified continuous optical signal,
wherein the second modulation signal is obtained by summing outputs of the third and fourth modulators with each other.

10. The optical logic element as claimed in claim 9, wherein the third modulator comprises:
a fourth optical amplifier performing XPM on the continuous optical signal in response to the sum signal; and
a second phase shifter shifting the phase of an output of the fourth optical amplifier by a predetermined amount, and
the fourth modulator comprises:
a fifth optical amplifier amplifying by a predetermined gain and outputting the continuous optical signal.

11. The optical logic element as claimed in claim 10, wherein, when the power of the input signal is less than a predetermined level, the fourth optical amplifier shifts the phase of the input signal by a predetermined amount, and when the power of the input signal is greater than the predetermined level, the fourth optical amplifier shifts the phase of the input signal by a predetermined amount.

12. The optical logic element as claimed in claim 11, wherein when power of the sum signal is at a high level, the fourth optical amplifier delays the phase of the continuous optical signal by π, when the power of the sum signal is at a low level, the fourth optical amplifier does not delay the phase of the continuous optical signal, the second phase shifter shifts the phase of an output of the fourth optical amplifier by (2n)π, where n is an integer, high level gains of the first, second, and third optical amplifiers and a gain of the fourth optical amplifier are equal to one another, and low level gains of the first, second, and third optical amplifiers are equal to one another.

13. The optical logic element as claimed in claim 12, wherein the second modulation signal is the result of a NOR operation performed on the first and second optical signals, and a sum signal equal to the sum of the first and second modulation signals is the result of a NAND operation performed on the first and second optical signals.

14. The optical logic element as claimed in claim 11, wherein, when the power of the sum signal is at a high level, the fourth optical amplifier delays the phase of the continuous optical signal by π, when the power of the sum signal is at a low level, the fourth optical amplifier does not delay the phase of the continuous optical signal, the second phase shifter shifts the phase of the output of the fourth optical amplifier by (2n+1)π, where n is an integer, high level gains of the first, second, and third optical amplifiers are equal to one another, and low level gains of the first, second, and third optical amplifiers and a gain of the fourth optical amplifier are equal to one another.

15. The optical logic element as claimed in claim 14, wherein the second modulation signal is the result of an OR performed on the first and second optical signals.

16. The optical logic element as claimed in claim 10, wherein the second phase shifter comprises a sixth optical amplifier performing SPM on the output of the fourth optical amplifier in response to the output of the fourth optical amplifier.

17. The optical logic element as claimed in claim 16, wherein the sum signal is directly input to the fourth optical amplifier.

18. The optical logic element as claimed in claim 9, wherein the third modulator comprises a third optical amplifier performing XPM on the continuous optical signal in response to the sum signal and delaying the phase of the phase modulated continuous optical signal by a predetermined amount.

19. The optical logic element as claimed in claim 2, wherein the first modulator comprises a first optical amplifier performing XPM on the continuous optical signal in response to the first optical signal and delaying the phase of the phase modulated continuous optical signal by a predetermined amount.

20. The optical logic element as claimed in claim 1, wherein the first and second interferometers are Mach-Zehnder interferometers (MZIs).

21. The optical logic element as claimed in claim 1, wherein the first and second interferometers are Michelson interferometers.

22. The optical logic element as claimed in claim 1, wherein at least of the first and second interferometers uses a co-propagation method, the optical logic element further comprising a band pass filter filtering out the input optical signals to output only a modulation signal.

23. The optical logic element as claimed in claim 22, wherein both the first and second interferometers use a co-propagation method, the band pass filter including:
a first band pass filter for filtering out the first and second optical to from an output of the first interferometer to output only the first modulation signal; and
a second band pass filter for filtering out the sum signal from an output of the second interferometer to output only a second modulation signal.
